(19) United States
(12) Patent Application Publication
(10) Pub. No.: US 2008/0022110 A1
(43) Pub. Date: Jan. 24, 2008

(54) Message authentication system and message authentication method

(75) Inventor: Jui-Sheng Hung, Changhua County (TW)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/819,997

(22) Filed: Jun. 29, 2007

(30) Foreign Application Priority Data
Jul. 5, 2006 (TW) 95124546

(51) Int. Cl. H04L 9/00

(52) U.S. Cl. 713/176

(57) ABSTRACT

A message authentication system includes a sender for sending a content message having a content and a signature, and a receiver for receiving the content message. The sender includes a first one-way hash function calculator for calculating a hash value of the content, and a decryption function calculator for decrypting the hash value according to a secure private key to generate the signature. The receiver includes a second one-way hash function calculator for calculating the hash value of the content, and an encryption function calculator for encrypting the signature according to a public key to generate an encrypted signature. The receiver authenticates the content message according to whether the hash value of the sender and the hash value of the encrypted signature are the same.

This application claims the benefit of Taiwan application Serial No. 95124546, filed Jul. 5, 2006, the subject matter of which is incorporated herein by reference.

### BACKGROUND OF THE INVENTION

1. Field of the Invention

The invention relates in general to a message system, and more particularly to a message authentication system and a message authentication method capable of automatically authenticating a message.

2. Description of the Related Art

A global system for mobile communication (GSM) is a digital mobile phone communication system having the widest distribution and the most customers after the analog mobile phone system (AMPS).

The GSM network message service includes a cell broadcast service (CBS) and a short message service (SMS).

In the CBS, a sender sends a message to each receiver in a coverage area through a base station, and the sender and the receiver may be mobile phones, for example. The broadcast channels typically range from 0 to 999, and the user can set one of the channels of the mobile phone to receive the broadcasted message. Each broadcasted message contains 82 octets, and one message may be composed of at most 15 pages. In general, the CBS is often applied to the sending of the real-time data such as the local information, the traffic condition and the weather report.

The SMS provides a message wireless sending service, and has the connectionless property, the low capacity and the low time performance (Not Real-Time). The SMS is applied to the sending of the text message between the mobile phones, wherein the message does not exceed 160 octets, and the message is sent first to a short message service center (SMSC) through the sender, and then the SMSC sends the message to the receiver in a short message deliver point-to-point format.

With the popularization of the mobile phones and the enhancement of the message input function of the mobile phone service provider, the typical users can use the mobile phones to send the messages, and more and more government organizations and financial institutions inform the multitudes or customers of some important news, such as the penalty delay and the credit card deduction.

However, the current mobile phone cannot automatically recognize the validity of the source of the message. Thus, some bandits send a lot of false messages to entrap the multitudes in the name of the government organizations or the financial institutions. Thus, some multitudes have become the victims of the chicane event. So, it is an important subject of the service provider to make the mobile phone automatically authenticate the validity of the source of the message.

### SUMMARY OF THE INVENTION

The invention is directed to a message authentication system and a message authentication method, in which a receiver can automatically authenticate an identification of a sender according to a signature of a message to prevent the consumer from becoming a victim of a chicane event.

According to a first aspect of the present invention, a message authentication system including a sender and a receiver is provided. The sender sends a content message, which comprises a content and a signature, and the receiver is for receiving the content message.

The sender includes a first one-way hash function calculator for calculating a hash value of the content, and a decryption function calculator for decrypting the hash value according to a secure private key to generate the signature.

The receiver includes a second one-way hash function calculator for calculating the hash value of the content, and an encryption function calculator for encrypting the signature according to a public key to generate an encrypted signature. The receiver authenticates a validity of a source of the content message according to whether the hash value of the sender and a hash value of the encrypted signature are the same.

According to a second aspect of the present invention, a message authentication method is provided.

The message authentication method is applied to a message authentication system, which comprises a sender and a receiver. The message authentication method includes the following steps.

First, the sender sends a content message, which comprises a content and a signature. The signature is obtained by decrypting a hash value of the content according to a secure private key.

Next, the receiver receives the content message and encrypts the signature according to a public key to generate an encrypted signature.

Finally, the receiver authenticates a validity of a source of the content message according to whether the hash value of the sender and a hash value of the encrypted signature are the same.

The invention will become apparent from the following detailed description of the preferred but non-limiting embodiment. The following description is made with reference to the accompanying drawings.

### BRIEF DESCRIPTION OF THE DRAWINGS

FIG. 1 is a block diagram showing a system for broadcasting a key message.

FIG. 2 is a schematic illustration showing the system for broadcasting the key message.

FIG. 3 is a schematic illustration showing a format of the key message.

FIG. 4 is a flow chart showing a method of a receiver for receiving the key message.

FIG. 5 is a block diagram showing the system for sending a content message.

FIG. 6 is a schematic illustration showing a format of the content message.

FIG. 7 is a block diagram showing a sender.

FIG. 8 is a block diagram showing the receiver.

FIG. 9 is a flow chart showing the method of the receiver for receiving the content message.

FIG. 10 is a schematic illustration showing a key database.

FIG. 11 is a flow chart showing a message authentication method.

### DETAILED DESCRIPTION OF THE INVENTION

### Broadcast Key Message

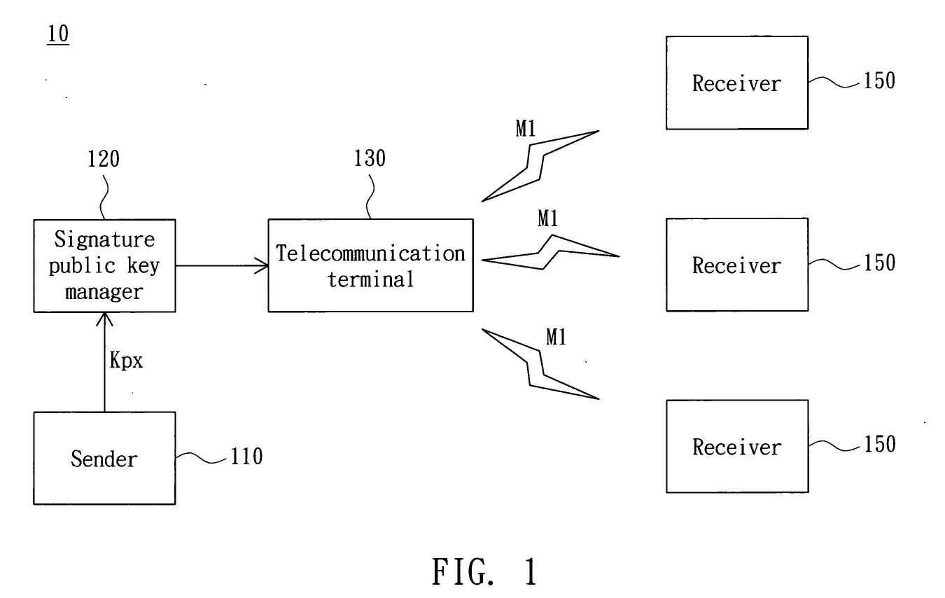

FIG. 1 is a block diagram showing a system for broadcasting a key message. Referring to FIG. 1, a message authentication system 10 includes a sender 110, a public key manager 120, a telecommunication terminal 130 and a receiver 150.

The sender 110 may be a government organization or a financial institution, for example. The sender 110 generates a public key Kpx and a secure private key Ksx that are paired, and sends the public key Kpx to the public key manager 120.

The public key manager 120 is managed by an accountable institution, which austerely checks on and authenticates the identification of the sender 110. In order to enhance the security of the message authentication system 10, the sender 110 regularly registers/updates the public key Kpx to the public key manager 120 through a pen-and-ink way or a network to prevent the public key Kpx from being cracked.

After registering/updating the public key Kpx, the public key manager 120 asks the telecommunication terminal 130 to broadcast a key message M1 having the public key Kpx to all the receivers 150 within the sending range using a cell broadcast service (CBS).

The receiver 150 may be a mobile phone, for example. The user can set a certain broadcast channel in the mobile phone as a key broadcast channel Ch(n) and receive the key message M1 with this key broadcast channel Ch(n).

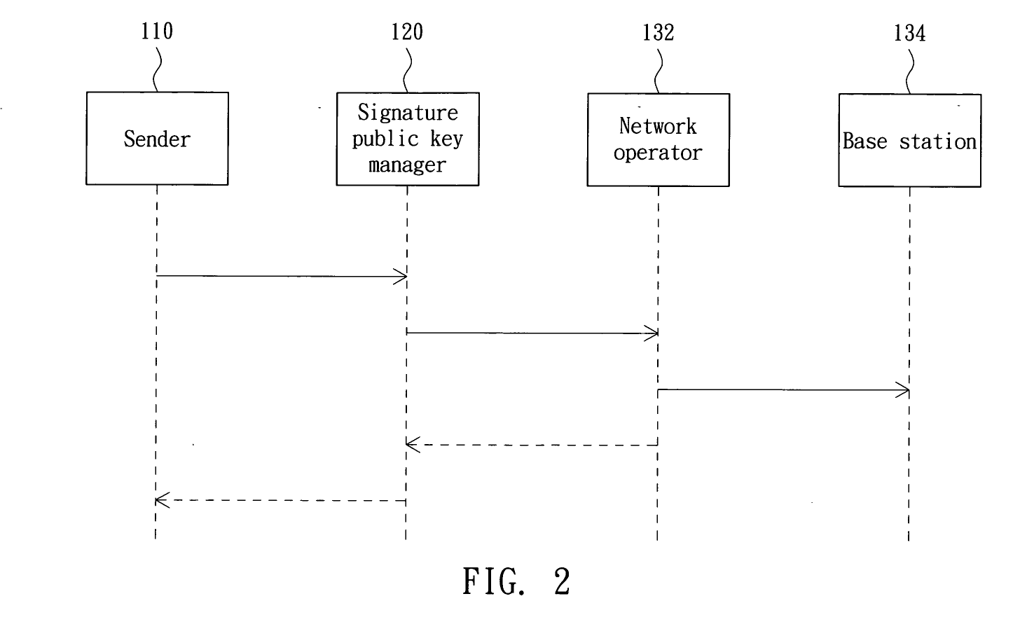

FIG. 2 is a schematic illustration showing the system for broadcasting the key message. As shown in FIG. 2, in order to ensure the sending of the public key Kpx to be valid, the public key manager 120 further authenticates the sender 110 after the valid sender 110 registers/updates the public key Kpx to the public key manager 120.

The telecommunication terminal 130 includes a network operator 132 and a base station 134. When the public key manager 120 asks the network operator 132 to broadcast the key message M1, the network operator 132 further authenticates the public key manager 120. After the authentication succeeds, the network operator 132 can broadcast the key message M1 from the key broadcast channel Ch(n) to the receiver 150 through the base station 134.

### Key Message Format

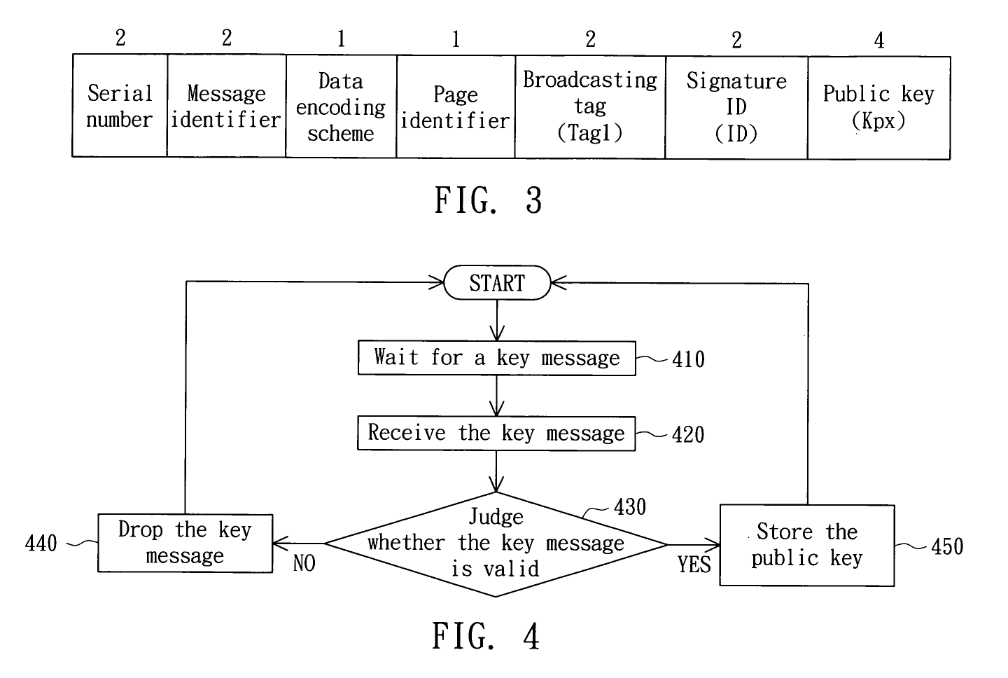

FIG. 3 is a schematic illustration showing a format of the key message. Referring to FIG. 3, the key message M1 includes a serial number, a message identifier, a data encoding scheme, a page identifier, a broadcasting tag Tag1, a signature identification ID and the public key Kpx. The serial number, the message identifier, the data encoding scheme and the page identifier are well known in the art, so detailed descriptions thereof will be omitted.

The added broadcasting tag Tag1 of this embodiment is for representing whether the key message M1 is valid, and different signature identifications ID correspond to different public keys Kpx. The receiver 150 stores the public key Kpx according to the signature identification ID.

### Receiver Receives Key Message

FIG. 4 is a flow chart showing a method of the receiver for receiving the key message. First, as shown in step 410, the receiver 150 waits for the key message M1 to be sent from the key broadcast channel Ch(n).

Next, as shown in step 420, the receiver 150 receives the key message M1.

Then, as shown in step 430, the receiver 150 judges whether the key message M1 is valid according to the broadcasting tag Tag1.

If the key message M1 is invalid, the key message M1 is dropped, as shown in step 440.

On the contrary, if the key message M1 is valid, the public key Kpx is stored according to the signature identification ID, as shown in step 450.

### Send Content Message

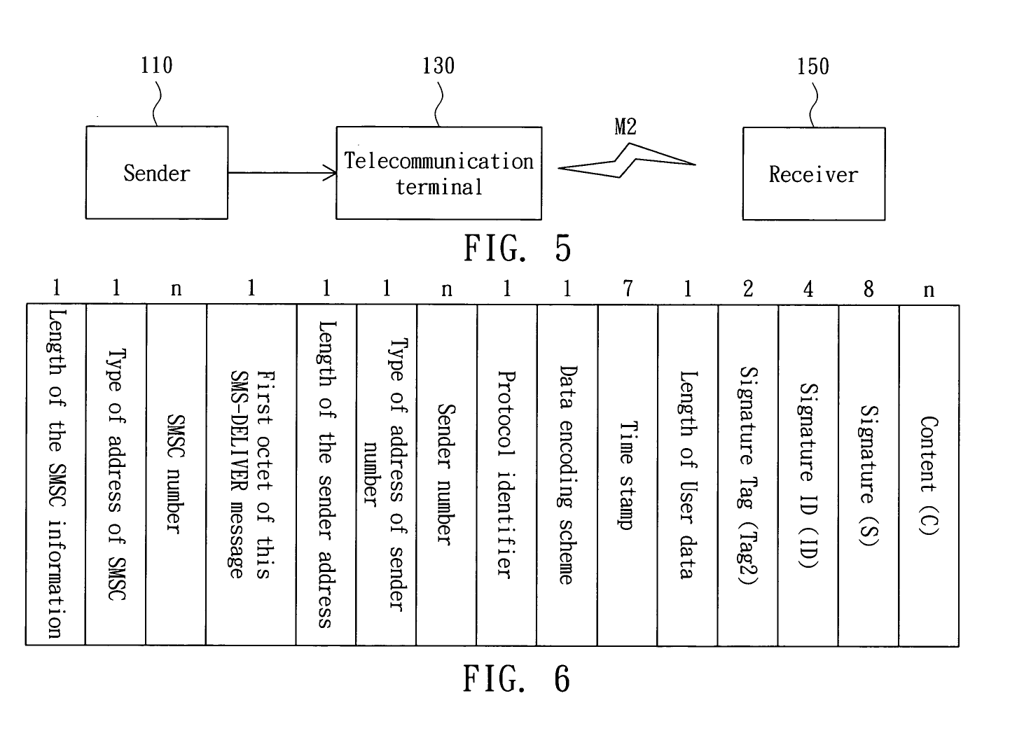

FIG. 5 is a block diagram showing the system for sending the content message. As shown in FIG. 5, the sender 110 asks the telecommunication terminal 130 to send the content message M2 to the receiver 150 using the short message service (SMS).

The receiver 150 can authenticate the validity of the source of the content message M2 according to the previously received public key Kpx and thus preclude the false message of the chicane group.

### Content Message Format

FIG. 6 is a schematic illustration showing a format of the content message. Referring to FIG. 6, the content message M2 includes a length of the short message service center (SMSC) information, a type of address of the SMSC, a SMSC number, a first octet of a SMS-DELIVER message, a length of the sender address, a sender number, a type of address of the sender number, a protocol identifier, a data encoding scheme, a time stamp, a length of user data, a signature tag Tag2, a signature ID, a signature S and a content C.

The length of the SMSC information, the type of address of the SMSC, the SMSC number, the first octet of the SMS-deliver message, the length of the sender address, the type of address of the sender number, the sender number, the protocol identifier, the data encoding scheme, the time stamp, the length of user data and the content C are well known in the art, so detailed descriptions thereof will be omitted.

The newly added signature tag Tag2 of this embodiment is for representing whether the content message M2 has to be authenticated. If the content message M2 has to be authenticated, the receiver 150 selects the corresponding public key Kpx according to the signature identification ID and encrypts the signature S according to the public key Kpx to authenticate the validity of the source of the content message M2.

### Sender

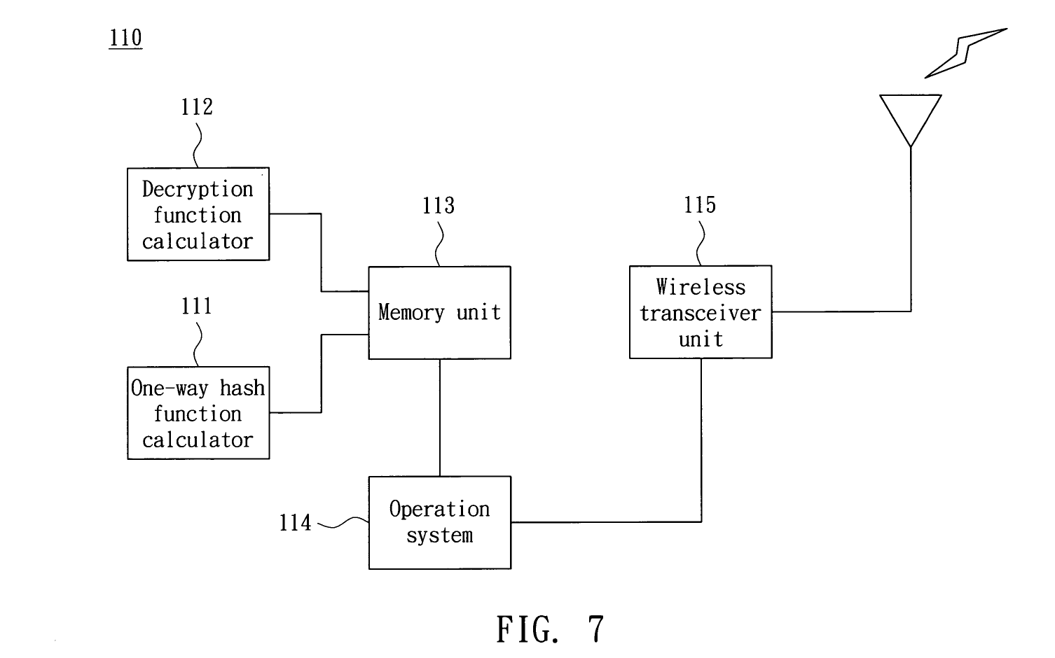

FIG. 7 is a block diagram showing the sender. Referring to FIG. 7, the sender 110 includes a one-way hash function calculator 111, a decryption function calculator 112, a memory unit 113, an operation system 114 and a wireless transceiver unit 115.

The one-way hash function calculator 111 calculates a hash value FH(C) of the content C using the one-way hash function. The memory unit 113 stores the public key Kpx and the secure private key Ksx, which are paired with each other.

The decryption function calculator 112 decrypts the hash value FH(C) according to the secure private key Ksx and a decryption function DA to generate the signature S, wherein S=DA(Ksx,FH(C)). The operation system 114 sends the content message M2 having the content C and the signature S to the telecommunication terminal 130 through the wireless transceiver unit 115 or the network. The telecommunication terminal 130 sends the content message M2 to the receiver 150 using the short message service.

### Receiver

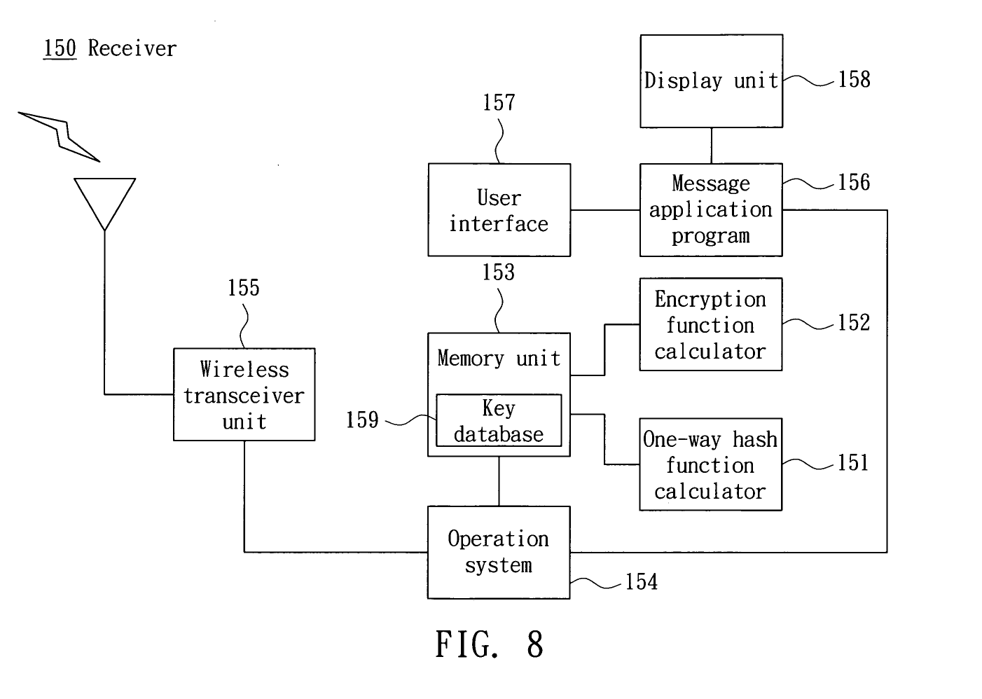

FIG. 8 is a block diagram showing the receiver 150. Referring to FIG. 8, the receiver 150 includes a one-way hash function calculator 151, an encryption function calculator 152, a memory unit 153, an operation system 154, a wireless transceiver unit 155, a message application program 156, a user interface 157 and a display unit 158.

After the wireless transceiver unit 155 receives the content message M2, the operation system 154 stores the content message M2 to the memory unit 153. The memory unit 153 further includes a key database 159 for storing the public key Kpx. The encryption function calculator 152 encrypts the signature S according to the public key Kpx and an encrypting function EA to generate an encrypted signature E, wherein E=EA(Kpx,S).

The one-way hash function calculator 151 further calculates the hash value FH(C) of the content C using the one-way hash function. The operation system 154 compares a hash value of the encrypted signature E with the hash value FH(C) of sender 110 to determine whether they are the same. If they are the same, it represents that the source of the content message M2 is valid; or otherwise the source of the content message M2 is invalid.

After the source of the content message M2 is authenticated to be valid, the content message M2 having the valid source on the display unit 158 can be displayed through the user interface 157 and the message application program 156.

### Receiver Receives Content Message

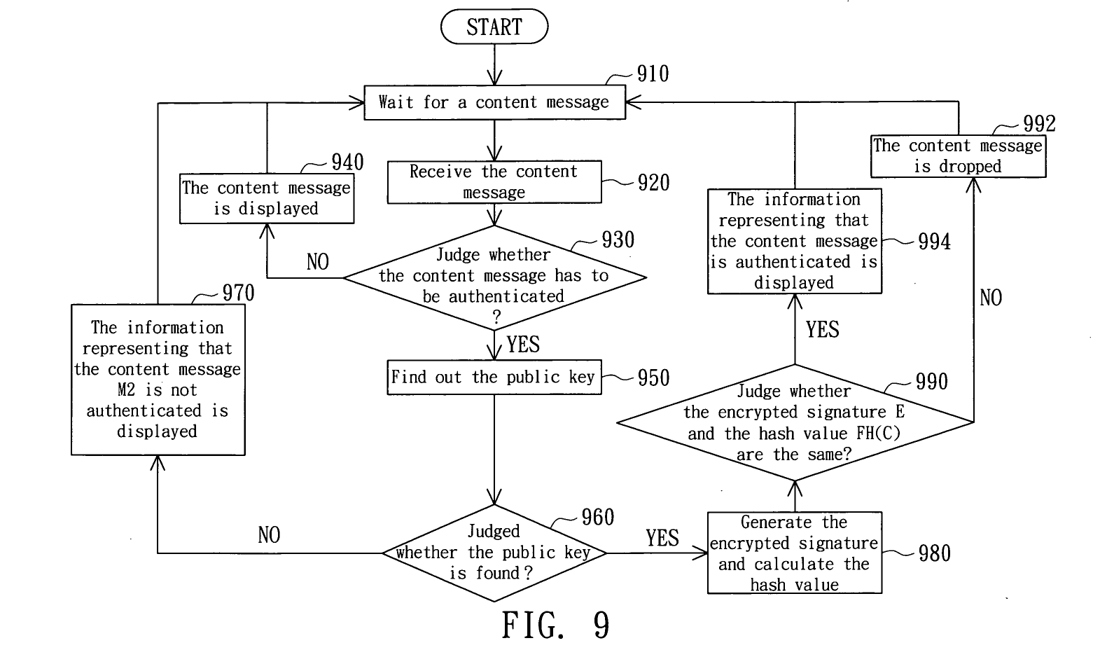

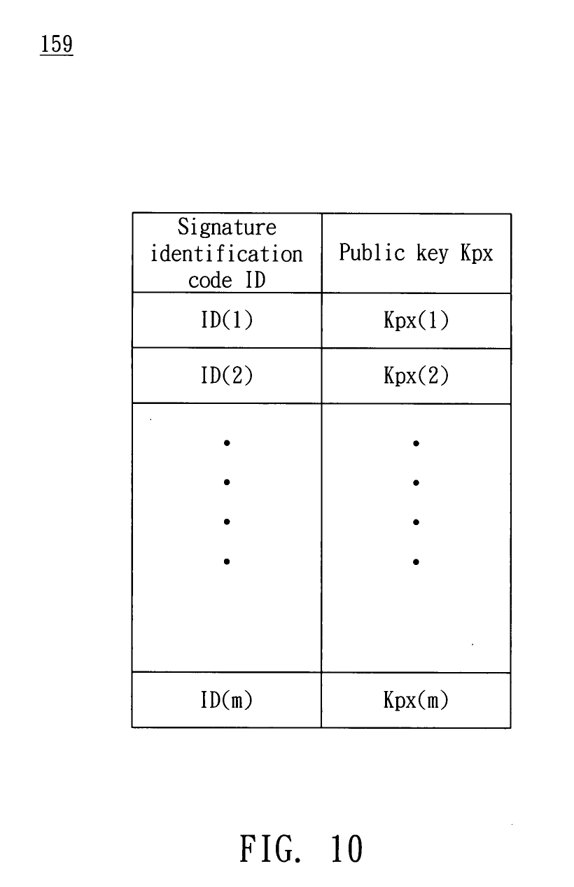

FIG. 9 is a flow chart showing the method of the receiver for receiving the content message. First, as shown in step 910, the receiver 150 waits for the content message M2 which is sent using the short message service by the mobile phone.

Next, as shown in step 920, the receiver 150 receives the content message M2.

Then, as shown in step 930, the receiver 150 judges whether the content message M2 has to be authenticated according to the signature tag Tag2.

If not, it represents that the content message M2 is only the typical daily message, and the validity of the source of the content message M2 does not have to be specially authenticated. Thus, as shown in step 940, the content message M2 is directly displayed on the display unit 158.

If the receiver 150 judges that the content message M2 has to be authenticated according to the signature tag Tag2, the receiver 150 finds out the corresponding public key Kpx from the key database 159 according to the signature identification ID, as shown in step 950.

Then, as shown in step 960, it is judged whether the public key Kpx corresponding to the signature identification ID in the key database 159 is found.

If not, as shown in step 970, the information representing that the content message M2 is not authenticated is displayed on the display unit 158.

Oppositely, if the receiver 150 has found out the corresponding public key Kpx from the key database 159 according to the signature identification ID, as shown in step 980, the signature S is encrypted according to the public key Kpx to generate the encrypted signature E, and the receiver 150 calculates the hash value FH(C) of the content C.

Next, as shown in step 990, it is judged whether the encrypted signature E and the hash value FH(C) are the same. If they are different from each other, the content message M2 is dropped, as shown in step 992.

Oppositely, if the encrypted signature E and the hash value FH(C) are the same, the information representing that the content message M2 has been authenticated is displayed on the display unit 158, as shown in step 994.

### Key Database

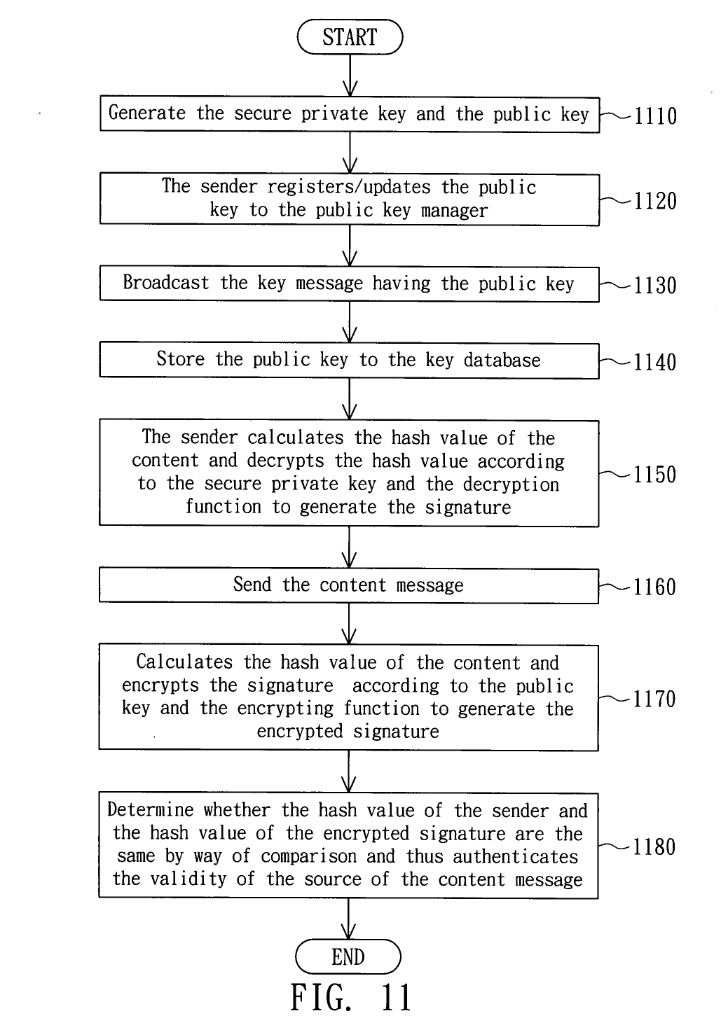

FIG. 10 is a schematic illustration showing a key database. Because different government organizations or financial institutions have their corresponding signature identifications ID, the public keys Kpx(1) to Kpx(m) are respectively stored to the key database 159 according to the signature identifications ID(1) to ID(m). The receiver 150 can select the corresponding public key Kpx according to the signature identification ID in the content message M2, and encrypt the signature S of the content message M2 according to the public key Kpx to authenticate the validity of the source of the content message M2.

### Message Authentication Method

FIG. 11 is a flow chart showing a message authentication method. As shown in FIG. 11, the message authentication method is applied to the message authentication system 10 and includes the following steps.

First, as shown in step 1110, the sender 110 generates the secure private key Ksx and the public key Kpx, which are paired with each other and have to satisfy the condition of the encrypted signature

E=EA(Kpx,S)=EA(Kpx,DA(Ksx,FH(C)))=FH(C).

Next, as shown in step 1120, the sender 110 registers/updates the public key Kpx to the public key manager 120.

Then, as shown in step 1130, the sender 110 asks the telecommunication terminal 130 to broadcast the key message M1 having the public key Kpx to each receivers 150 using the cell broadcast service (CBS).

Next, as shown in step 1140, the receiver 150 stores the public key Kpx to the key database 159.

Then, as shown in step 1150, the sender 110 calculates the hash value FH(C) of the content C and decrypts the hash value FH(C) according to the secure private key Ksx and the decryption function DA to generate the signature S.

Next, as shown in step 1160, the sender 110 asks the telecommunication terminal 130 to send the content message M2 having the content C to the receiver 150 using the SMS by the mobile phone.

Then, as shown in step 1170, the receiver 150 calculates the hash value FH(C) of the content C and encrypts the signature S according to the public key Kpx and the encrypting function EA to generate the encrypted signature E.

Next, as shown in step 1180, the receiver 150 determines whether the hash value FH(C) of the sender 110 and the hash value FH(C) of the encrypted signature E are the same by way of comparison and thus authenticates the validity of the source of the content message M2. For example, if they are the same, it represents that the content message M2 is indeed sent from the valid source, such as the government organization or the financial institution. Oppositely, if they are different from each other, it represents that the content message M2 may be sent from the invalid source such as the chicane group.

As mentioned hereinabove, the sender 110 calculates the hash value FH(C) of the content C and decrypts the hash value FH(C) according to the secure private key Ksx and the decryption function DA to generate the signature S. The receiver 150 encrypts the signature S according to the public key Kpx to generate the encrypted signature E. The receiver 150 can authenticate whether the source of the content message M2 is valid according to whether the hash value FH(C) of the encrypted signature E is the same as the hash value FH(C) of the sender 110.

In the message authentication system and the message authentication method according to the embodiment of the invention, the receiver can automatically differentiate the validity of the source of the message to prevent the user from becoming the victim of the chicane event.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A message authentication system, comprising:
a sender for sending a content message, which comprises a content and a signature, the sender comprising:
a first one-way hash function calculator for calculating a hash value of the content; and
a decryption function calculator for decrypting the hash value according to a secure private key to generate the signature; and
a receiver for receiving the content message, the receiver comprising:
a second one-way hash function calculator for calculating the hash value of the content; and
an encryption function calculator for encrypting the signature according to a public key to generate an encrypted signature, wherein the receiver authenticates the content message according to whether the hash value of the sender and a hash value of the encrypted signature are the same.

2. The system according to claim 1, further comprising a public key manager, wherein the sender registers/updates the public key to the public key manager.

3. The system according to claim 2, further comprising a telecommunication terminal, wherein the public key manager asks the telecommunication terminal to broadcast a key message having the public key to the receiver using a cell broadcast service (CBS).

4. The system according to claim 3, wherein the key message further comprises a broadcasting tag for representing whether the key message is valid, and a signature identification corresponding to the public key.

5. The system according to claim 1, wherein the secure private key and the public key are generated by the sender, and the secure private key and the public key make the hash value of the sender and the hash value of the encrypted signature be the same.

6. The system according to claim 1, wherein the receiver comprises a key database for storing the public key.

7. The system according to claim 1, further comprising a telecommunication terminal, wherein the sender asks the telecommunication terminal to send the content message to the receiver using a short message service (SMS).

8. The system according to claim 1, wherein the content message further comprises a signature tag for representing whether the content message has to be authenticated, and a signature identification corresponding to the public key.

9. The system according to claim 1, wherein the receiver is a mobile phone.

10. A message authentication method applied to a message authentication system, which comprises a sender and a receiver, the method comprising the steps of:
sending, by the sender, a content message, the content message comprising a content and a signature, which is obtained by decrypting a hash value of the content according to a secure private key;
receiving, by the receiver, the content message, and encrypting the signature according to a public key to generate an encrypted signature; and
authenticating, by the receiver, the content message according to whether the hash value of the sender and a hash value of the encrypted signature are the same.

11. The method according to claim 10, wherein the public key and the secure private key make the hash value of the sender and the hash value of the encrypted signature be the same.

12. The method according to claim 10, further comprising the step of:
broadcasting a key message having the public key to the receiver.

13. The method according to claim 12, wherein the key message further comprises a broadcasting tag for representing whether the key message is valid, and a signature identification corresponding to the public key.

14. The method according to claim 12, wherein the broadcasting step comprises:
generating, by the sender, the public key and the secure private key;
registering/updating, by the sender, the public key to a public key manager; and
asking, by the public key manager, a telecommunication terminal to broadcast the key message to the receiver.

15. The method according to claim 14, wherein the public key manager asks the telecommunication terminal to broadcast the key message to the receiver using a cell broadcast service (CBS).

16. The method according to claim 10, wherein the sending step comprises:
calculating the hash value of the content using a one-way hash function;
decrypting the hash value according to the secure private key to generate the signature; and
asking, by the sender, a telecommunication terminal to send the content message to the receiver.

17. The method according to claim 16, wherein the sender asks the telecommunication terminal to send the content message to the receiver using a short message service (SMS).

18. The method according to claim 10, wherein the receiving step comprises:
receiving the content message by the receiver;
calculating the hash value of the content using a one-way hash function; and
encrypting the signature according to the public key to generate the encrypted signature.

19. The method according to claim 10, wherein the content message further comprises a signature tag for representing whether the content message has to be authenticated, and a signature identification corresponding to the public key.

20. The method according to claim 10, wherein the receiver comprises a key database for storing the public key.
